(19) United States
(12) Patent Application Publication
(10) Pub. No.: US 2026/0222003 A1
(43) Pub. Date: Jul. 30, 2026

(54) DEVICE FOR CONTROLLING IMPEDANCE OF ANTENNA TUNER, COMMUNICATION DEVICE INCLUDING THE SAME, AND METHOD OF OPERATING THEREOF

(71) Applicant: SAMSUNG ELECTRONICS CO., LTD., Suwon-si (KR)

(72) Inventors: Sunah PARK, Suwon-si (KR); Seunghun Park, Suwon-si (KR); Changeon Park, Suwon-si (KR); Seunghyun Oh, Suwon-si (KR)

(73) Assignee: SAMSUNG ELECTRONICS CO., LTD., Suwon-si (KR)

(21) Appl. No.: 19/407,848

(22) Filed: Dec. 3, 2025

(30) Foreign Application Priority Data
Jan. 24, 2025 (KR) 10-2025-0010932

(51) Int. Cl. H04B 1/40; H01Q 1/22

(52) U.S. Cl. CPC H04B 1/40; H01Q 1/22

(57) ABSTRACT

Provided is a communication device including an antenna tuner configured to adjust impedance based on a first tune code; and a processor configured to: obtain a first reflection coefficient of the antenna tuner based on a forward signal transmitted to an antenna through the antenna tuner and a reverse signal received through the antenna tuner, the reverse signal including at least a portion of a reflected signal of the forward signal; obtain a second reflection coefficient of the antenna based on the first reflection coefficient and a first scattering parameter (S-parameter) set corresponding to the first tune code; and generate a second tune code based on the second reflection coefficient.

### CROSS-REFERENCE TO RELATED APPLICATIONS

This application is based on and claims priority to Korean Patent Application No. 10-2025-0010932, filed on Jan. 24, 2025, in the Korean Intellectual Property Office, the disclosure of which is incorporated by reference herein in its entirety.

### BACKGROUND

### 1. Field

Example embodiments relate to wireless communications, and more particularly, to a device for controlling impedance of an antenna tuner, a communication device including the device, and a method of operating the device.

### 2. Description of Related Art

In a wireless communication system, an antenna tuner may adjust impedance in order to reduce return loss. For example, a bypass tune code may be used as a reference point in the process of calculating a reflection coefficient to set an optimum tune code. However, repeated changes to the bypass tune code may cause a risk of degrading durability of the antenna tuner or increasing return loss. Therefore, a measure to address such risks is required.

### SUMMARY

Embodiments of the disclosure provide a device for controlling impedance of an antenna tuner to minimize durability degradation and return loss, a communication device including the same, and an operating method thereof.

According to an aspect of the disclosure, a communication device includes: an antenna tuner configured to adjust impedance based on a first tune code; and a processor configured to: obtain a first reflection coefficient of the antenna tuner based on a forward signal transmitted to an antenna through the antenna tuner and a reverse signal received through the antenna tuner, the reverse signal including at least a portion of a reflected signal of the forward signal; obtain a second reflection coefficient of the antenna based on the first reflection coefficient and a first scattering parameter (S-parameter) set corresponding to the first tune code; and generate a second tune code based on the second reflection coefficient.

According to an aspect of the disclosure, an operating method of a device for controlling impedance of an antenna tuner, includes: providing a first tune code to the antenna tuner to adjust impedance; obtaining a first reflection coefficient of the antenna tuner based on a forward signal transmitted to an antenna through the antenna tuner and a reverse signal received through the antenna tuner, the reverse signal including at least a portion of a reflected signal of the forward signal; obtaining a second reflection coefficient of the antenna based on the first reflection coefficient and first scattering parameter (S-parameter) set corresponding to the first tune code; and generating a second tune code based on the second reflection coefficient.

According to an aspect of the disclosure, a device configured to control impedance of an antenna tuner, includes: a buffer configured to store a lookup table including a plurality of tune codes; and an antenna controller configured to provide a first tune code to the antenna tuner, wherein the antenna controller is configured to: receive a first signal corresponding to a forward signal transmitted to an antenna through the antenna tuner; receive a second signal corresponding to a reverse signal received through the antenna tuner, the reverse signal including at least a portion of a reflected signal of the forward signal; obtain a first reflection coefficient of the antenna tuner based on the first signal and the second signal; obtain a second reflection coefficient of the antenna based on the first reflection coefficient and the first tune code; and generate a second tune code based on the second reflection coefficient and the lookup table.

According to one or more example embodiments, a device for controlling impedance of an antenna tuner, a communication device including the same, and an operating method thereof, may minimize durability degradation and return loss.

According to one or more example embodiments, it may be possible to increase communication quality through rapid and stable impedance matching in various frequency bands. According to one or more example embodiments, it may be possible to reduce power consumption of signal transmission and extend antenna tuner life.

Effects and aspects of example embodiments are not limited to those described above, and other unstated effects may be clearly derived and understood by those skilled in the art to which example embodiments pertain from the following description. In other words, unintended effects that may be obtained by implementing example embodiments may also be derived by those skilled in the art from example embodiments.

### BRIEF DESCRIPTION OF DRAWINGS

The above and/or other aspects, features, and advantages of the present disclosure will become apparent and more readily appreciated from the following description of example embodiments, taken in conjunction with the accompanying drawings in which:

FIG. 1 is a block diagram illustrating a communication device according to one or more example embodiments of the disclosure;

FIG. 2 is a block diagram illustrating a communication device according to one or more example embodiments of the disclosure;

FIG. 3 is a diagram for illustrating a communication device according to one or more example embodiments of the disclosure;

FIG. 4 is a flowchart illustrating an operating method of a device for controlling impedance of an antenna tuner according to one or more example embodiments of the disclosure;

FIG. 5 is a flowchart illustrating a method of identifying a reflection coefficient according to one or more example embodiments of the disclosure;

FIG. 6 is a diagram for illustrating a lookup table according to one or more example embodiments of the disclosure;

FIG. 7 is a flowchart illustrating a method of selecting a new tune code according to one or more example embodiments of the disclosure;

FIGS. 8A and 8B are diagrams for illustrating one or more example embodiments of generating a new tune code; and

FIG. 9 is a block diagram illustrating an example of a communication device according to one or more example embodiments of the disclosure.

### DETAILED DESCRIPTION

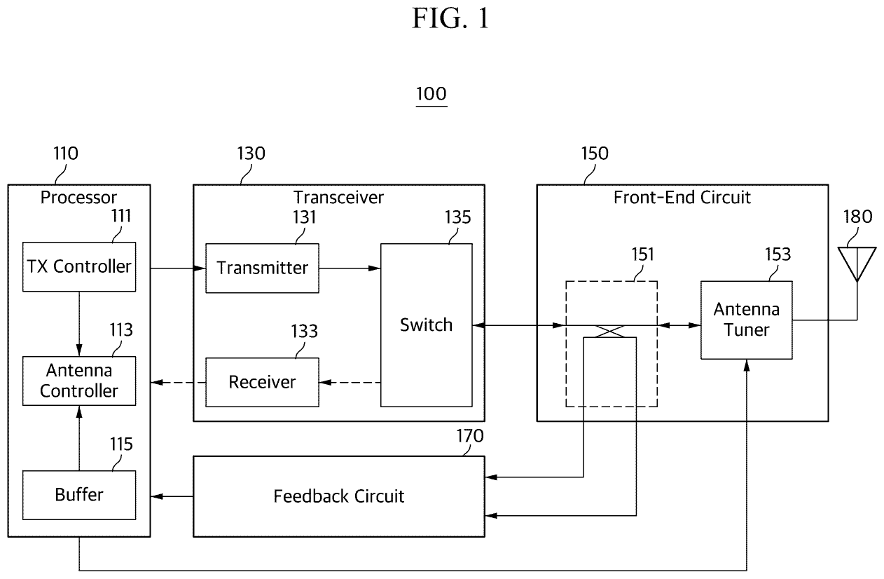

FIG. 1 is a block diagram illustrating a communication device 100 according to example embodiments of the disclosure. Referring to FIG. 1, the communication device 100 may include a processor 110, a transceiver 130, a front-end circuit 150, a feedback circuit 170, and an antenna 180. However, the disclosure is not limited thereto, and as such, according to an embodiment, in the communication device 100, one or more components may be added, omitted or combined. For example, a number and/or a type of processor may be different. For example, the number and/or a type of memory may be different. For example, the number and/or a type of antenna may be different.

The communication device 100 may communicate with an external device through the antenna 180. For example, the communication device 100 may transmit a signal to the external device or receive a signal from the external device through the antenna 180. For example, the communication device 100 may be implemented in various forms such as, but not limited to, a semiconductor chip for communication, a network interface card (NIC), a smartphone, a tablet personal computer (PC), a wearable device, a connected car, a communications satellite, and a mobile communication base station.

In an example embodiment, the communication device 100 may transmit and receive signals using a cellular network such as, but not limited to, 5th generation (5G), long term evolution (LTE), LTE-advanced, code division multiple access (CDMA), and global system for mobile communications (GSM). In an example embodiment, the communication device 100 may transmit and receive signals using a communication manner such as Bluetooth, near field communication (NFC), wireless fidelity (Wi-Fi), Zigbee, wireless local area network (WLAN), vehicle to everything (V2X), and satellite communication. The above-described examples are merely an example embodiment, and the communication device 100 may transmit and receive signals using various wireless communication manners.

The antenna 180 may be connected to the front-end circuit 150. The antenna 180 may transmit a signal (for example, a forward signal) transmitted from the front-end circuit 150 to the external device. The antenna 180 may transmit a signal (for example, a received signal) received from the external device to the front-end circuit 150. The forward signal may be at least a portion of a transmission signal generated in a transmitter 131 of the transceiver 130. The forward signal may proceed or propagate along a transmission path leading from the transceiver 130 to the front-end circuit 150 and the antenna 180. A direction of the forward signal proceeding along the transmission path may be referred to as a forward direction.

The antenna 180 may have a unique load impedance in a specific frequency band. In an example case in which a load impedance of the antenna 180 and a reference impedance of the transmission path are not matched, a portion of the forward signal proceeding along the transmission path may be reflected. For example, the reference impedance may be 50 ohm ((2). Here, a reflected signal may be referred to as a reverse signal, and the reverse signal may proceed along a reverse direction of the transmission path. For example, the reverse signal may proceed (or propagate) in an opposite direction of the forward direction. In one or more example embodiments, the load impedance of the antenna 180 may change due to various environmental factors such as the approach of an object or a user and a temperature change. In one or more example embodiments, to compensate for a change in the load impedance, the antenna 180 may be connected to an antenna tuner 153 included in the front-end circuit 150. By adjusting a variable impedance of the antenna tuner 153, impedance matching between the load impedance and the reference impedance may be performed. In an example embodiment, the communication device 100 may include a plurality of antennas for a phased array or multiple-input and multiple-output (MIMO).

The front-end circuit 150 may be connected to the transceiver 130 and the antenna 180. The front-end circuit 150 may transmit a signal (for example, the forward signal) transmitted from the transceiver 130 to the antenna 180. The front-end circuit 150 may transmit a signal (for example, the received signal) received from the antenna 180 or a signal (for example, the reverse signal) reflected from the antenna 180 to the transceiver 130. In one or more example embodiments, the front-end circuit 150 may include a coupler 151 and the antenna tuner 153. The coupler 151 may be connected between the transceiver 130 and the antenna tuner 153. The antenna tuner 153 may be connected between the coupler 151 and the antenna 180.

The coupler 151 may transmit the transmission signal transmitted from the transmitter 131 of the transceiver 130 to the antenna tuner 153 in a transmission mode. The coupler 151 may transmit the received signal transmitted from the antenna tuner 153 to a receiver 133 of the transceiver 130 in a reception mode. The coupler 151 may capture at least one of the forward signal and the reverse signal as a feedback signal and provide the feedback signal to the feedback circuit 170. For example, the coupler 151 may set a coupling direction as a forward coupling direction or a reverse coupling direction. In an example case in which the forward coupling direction is set, the coupler 151 may capture a feedback forward signal from the forward signal. In an example case in which the reverse coupling direction is set, the coupler 151 may capture a feedback reverse signal from the reverse signal. The feedback forward signal and the feedback reverse signal may be a signal coupled to the forward signal and a signal coupled to the reverse signal, respectively. In one or more example embodiments, the coupling direction of the coupler 151 may be set according to a coupler control signal provided from an antenna controller 113. In one or more example embodiments, the coupler 151 may be referred to as a bidirectional coupler.

The antenna tuner 153 may have the variable impedance. The antenna tuner 153 may compensate for the load impedance of the antenna 180. For example, the antenna tuner 153 may compensate for the load impedance of the antenna 180 by adjusting the variable impedance based on (or according to) a tune code. For example, the tune code may be provided from the antenna controller 113. In one or more example embodiments, the tune code may include information about a set value for adjusting the variable impedance within the antenna tuner 153.

According to an embodiment, the feedback circuit 170 may receive the feedback signal (for example, the feedback forward signal or the feedback reverse signal) provided from the coupler 151 and process the feedback signal to generate a baseband feedback signal. The baseband feedback signal may be a digital signal, and the feedback signal may be a radio frequency (RF) signal. As described above, the feedback forward signal may be a signal extracted from the forward signal, and the feedback reverse signal may be a signal extracted from the reverse signal. In one or more example embodiments, the feedback circuit 170 may include, but is not limited to, a filter, a mixer, and an analog-to-digital (A/D) converter. In one or more example embodiments, the feedback circuit 170 may analyze the feedback signal to generate feedback data for monitoring and optimizing reflection performance in the transmission path in real time. The feedback data may include characteristic information of each of the forward signal (or the feedback forward signal) and the reverse signal (or the feedback reverse signal). For example, the characteristic information may include an amplitude and a phase. As another example, the characteristic information may include information on an in-phase (I) component and a quadrature-phase (Q) component used to calculate an amplitude and a phase. The feedback circuit 170 may provide the feedback data to a buffer 115. In one or more example embodiments, a function of the feedback circuit 170 may be modified and implemented in a form integrated into the antenna controller 113.

The transceiver 130 may be connected to the processor 110 and the front-end circuit 150. The transceiver 130 may include the transmitter 131, the receiver 133, and a switch 135. The transmitter 131 may process a baseband transmission signal provided from the processor 110 to generate the transmission signal and transmit the transmission signal to the coupler 151. For example, the baseband transmission signal may be a digital signal, and the transmission signal may be an RF signal of a specific frequency band. In one or more example embodiments, the transmitter 131 may include a filter, a mixer, and a power amplifier. The receiver 133 may process the received signal transmitted from the coupler 151 to generate a baseband received signal and transmit the baseband received signal to the processor 110. For example, the baseband received signal may be a digital signal, and the received signal may be an RF signal. In one or more example embodiments, the receiver 133 may include a filter, a mixer, and a low noise amplifier. The switch 135 may be set in a transmission mode or a reception mode and may dynamically convert between the transmission mode and the reception mode. The transmission signal generated in the transmitter 131 may be transmitted to the antenna 180 through the front-end circuit 150 in the transmission mode, and the received signal received from the antenna 180 may be transmitted to the receiver 133 through the front-end circuit 150 in the reception mode. In one or more example embodiments, the switch 135 may include a duplexer and/or a switchplexer or may be replaced therewith.

The processor 110 may control overall operations of the communication device 100. For example, the processor 110 may generate a control signal for controlling an operation of a component of the communication device 100 and provide the control signal to the component. The processor 110 may process the feedback data provided from the feedback circuit 170 to perform an operation for impedance matching. Herein, the processor 110 may be referred to as a device for controlling impedance of the antenna tuner 153. In one or more example embodiments, the processor 110 may be implemented in various forms to control the overall operations of the communication device 100. For example, the processor 110 may be implemented in various forms such as, but not limited to, a microcontroller, a central processing unit (CPU), a network processing unit (NPU), a digital signal processor (DSP), and an application specific integrated circuit (ASIC). In one or more example embodiments, the processor 110 may be implemented as a hardware circuit, a processing unit including at least one processor and software blocks executed in the processor, or a combination thereof.

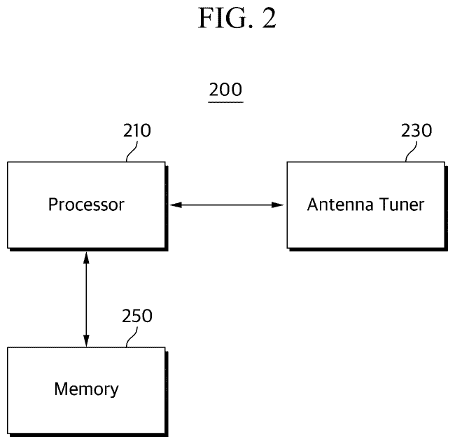

According to an embodiment, the processor 110 may include a transmission (TX) controller 111, the antenna controller 113, and the buffer 115. In one or more example embodiments, the processor 110 may execute a series of instructions, and the TX controller 111 and/or the antenna controller 113 may be a software module including a plurality of executable instructions. In one or more example embodiments, the processor 110 may include a logic circuit designed by logic synthesis, and the TX controller 111 and/or the antenna controller 113 may be a logic circuit. According to an embodiment, the TX controller 111 and the antenna controller 113 may be implemented as separate controllers. However, the disclosure is not limited thereto, and as such, according to an embodiment, the TX controller 111 and the antenna controller 113 may be implemented as a single controller. In one or more example embodiments, the buffer 115 may be included in an external memory (for example, memory 250 of FIG. 2) of the processor 110. The TX controller 111 may set various transmission parameters related to the transmission signal generated in the transmitter 131. For example, the transmission parameters may include parameters such as, but not limited to, a frequency band, output power, and a modulation manner of the transmission signal. In addition, the TX controller 111 may adjust the transmission signal to be transmitted to the antenna 180 based on a predetermined time point or a predetermined time interval by controlling a timing of the transmission signal generated or a timing of the transmission signal transmitted by the transmitter 131.

The buffer 115 may store data related to the processor 110. For example, the buffer 115 may temporarily store program instructions being executed by the processor 110, intermediate or result data generated in an operation process, and data transmitted and received in a communication process with the external device. In one or more example embodiments, the buffer 115 may include volatile memory such as static random access memory (SRAM) and dynamic RAM (DRAM). In one or more example embodiments, the buffer 115 may include non-volatile memory such as NAND flash memory. The buffer 115 may temporarily store the feedback data provided from the feedback circuit 170. The buffer 115 may provide the feedback data to the antenna controller 113 or other components. In one or more example embodiments, the buffer 115 may store a lookup table. The lookup table may include a plurality of tune codes. The lookup table may include parameter information corresponding to each tune code. For example, the lookup table may include a plurality of scattering parameter (S-parameter) sets corresponding to each tune code.

The antenna controller 113 may control the front-end circuit 150 to optimize impedance matching. For example, the antenna controller 113 may control the coupling direction of the coupler 151 or adjust the impedance of the antenna tuner 153.

In one or more example embodiments, the antenna controller 113 may provide the coupler control signal to the coupler 151 to control the coupling direction of the coupler 151 to be the forward coupling direction or the reverse coupling direction. The coupler 151 may selectively capture the feedback forward signal and the feedback reverse signal according to the coupler control signal and provide a captured signal to the feedback circuit 170. The antenna controller 113 may receive the feedback data provided from the feedback circuit 170 through the buffer 115.

In one or more example embodiments, the antenna controller 113 may generate a tune code. The tune code may be a code value for adjusting a value of the variable impedance of the antenna tuner 153. The antenna controller 113 may provide (or set) the tune code for the antenna tuner 153. For example, providing (or setting) the tune code may represent transmitting the tune code or a tuner control signal to adjust the impedance of the antenna tuner 153 to a value corresponding to the tune code.

In one or more example embodiments, the antenna controller 113 may generate a tune code based on transmission parameter information provided from the TX controller 111. For example, the antenna controller 113 may identify a change of a frequency band using the transmission parameter information. In an example case in which the frequency band is changed, the antenna controller 113 may generate an initial tune code corresponding to the changed frequency band. For example, if the frequency band is changed (or initialized), the antenna controller 113 may retrieve the initial tune code corresponding to the frequency band from the lookup table and generate the initial tune code from a retrieved result.

In one or more example embodiments, the antenna controller 113 may generate a tune code based on the feedback data including the characteristic information of each of the forward signal and the reverse signal. For example, the antenna controller 113 may identify a first reflection coefficient of the antenna tuner 153 corresponding to a tune code based on the forward signal and the reverse signal. The antenna controller 113 may identify a second reflection coefficient of the antenna 180 based on the first reflection coefficient. The antenna controller 113 may generate a new tune code based on the second reflection coefficient and provide the new tune code to the antenna tuner 153.

The antenna controller 113 may receive the feedback forward signal corresponding to the forward signal transmitted to the antenna 180 through the antenna tuner 153. For example, the feedback forward signal may be referred to as a first signal herein. The first signal may include information on a magnitude and a phase of the forward signal. The antenna controller 113 may receive the feedback reverse signal corresponding to the reverse signal received through the antenna tuner 153 as at least a portion of the forward signal is reflected. For example, the feedback reverse signal may be referred to as a second signal herein. The second signal may include information on a magnitude and a phase of the reverse signal. The antenna controller 113 may identify the first reflection coefficient of the antenna tuner 153 based on the first signal and the second signal. The first reflection coefficient may be an input reflection coefficient as seen from an input port of the antenna tuner 153. The antenna controller 113 may identify the second reflection coefficient of the antenna 180 based on the first reflection coefficient and the tune code. The second reflection coefficient may be a load reflection coefficient as seen from an input port of the antenna 180. The antenna controller 113 may generate the new tune code based on the second reflection coefficient and the lookup table. For example, the antenna controller 113 may retrieve a tune code corresponding to a value based on the second reflection coefficient from the lookup table to generate the new tune code.

FIG. 2 is a block diagram illustrating a communication device 200 according to one or more example embodiments of the disclosure.

Referring to FIG. 2, the communication device 200 may include a processor 210, an antenna tuner 230, and a memory 250. However, the disclosure is not limited thereto, and as such, according to an embodiment, in the communication device 200, one or more components may be added, omitted or combined. For example, a number and/or a type of processor may be different. For example, the number and/or a type of memory may be different. In one or more example embodiments, the communication device 200 of FIG. 2 may be an example of the communication device 100 of FIG. 1.

The processor 210 may generate a tune code for adjusting impedance of the antenna tuner 230. For example, the processor 210 may generate the tune code based on a lookup table stored in the memory 250. For example, the processor 210 may generate the tune code with reference to a lookup table stored in the memory 250. The processor 210 may provide the generated tune code to the antenna tuner 230.

The antenna tuner 230 may be connected to an antenna. The antenna tuner 230 may have a variable impedance for dynamically compensating for a load impedance of the antenna. The antenna tuner 230 may include at least one of an inductor, a capacitor, a transformer, a diode, a transistor, and an RF switch in order to have the variable impedance. In some example cases, the antenna tuner 230 may further include an amplifier or a resistor. The antenna tuner 230 may have an impedance adjusted according to the tune code provided from the processor 210.

The memory 250 may store a variety of data. The processor 210 may access data stored in the memory 250. In one or more example embodiments, the memory 250 may include non-volatile memory. For example, the non-volatile memory may include, but is not limited to, NAND flash memory and resistive memory. In one or more example embodiments, the memory 250 may include volatile memory. For example, the volatile memory may include, but is not limited to, SRAM and DRAM. The memory 250 may store the lookup table. The lookup table may include a plurality of tune codes and a plurality of S-parameter sets that are mapped to each other.

The processor 210 may identify a first reflection coefficient of the antenna tuner 230 based on a forward signal and a reverse signal. The forward signal may be a signal transmitted to the antenna through the antenna tuner 230. The forward signal may be a signal corresponding to at least a portion of a transmission signal. The reverse signal may be a signal received through the antenna tuner 230. For example, the reverse signal may be a signal corresponding to at least a portion of the forward signal that is reflected. For example, the reverse signal may be a signal corresponding to at least a portion of a reception signal that includes at least a portion of the reflection of the transmission signal. In one or more example embodiments, the first reflection coefficient may be a ratio of the forward signal and the reverse signal. For example, the ratio may be a magnitude (or amplitude) ratio of signals. In one or more example embodiments, the first reflection coefficient may be a ratio of a feedback forward signal corresponding to the forward signal and a feedback reverse signal corresponding to the reverse signal. The feedback forward signal and the feedback reverse signal may be a signal extracted from the forward signal and the reverse signal, respectively, and transmitted through a feedback path.

The processor 210 may identify a second reflection coefficient of the antenna based on the first reflection coefficient and an S-parameter set corresponding to a tune code. Here, the tune code may be a tune code currently set for the antenna tuner 230. Each S-parameter set may include a plurality of S-parameters. Each S-parameter may indicate a ratio of a signal reflected from, or transmitted to another port from, a signal inputted to a specific port in a multiport network.

The processor 210 may generate a new tune code based on the second reflection coefficient. For example, the processor 210 may retrieve a tune code corresponding to a value based on the second reflection coefficient from the lookup table to generate the new tune code. Accordingly, the processor 210 may dynamically adjust the impedance of the antenna tuner 230 to minimize a return loss of the forward signal and increase transmission efficiency. The communication device 200 of the disclosure may generate the new tune code based on the second reflection coefficient indicating a reflection characteristic of the antenna to minimize return loss generated in the antenna and optimize impedance matching in real time. According to one or more example embodiments, since the first reflection coefficient reflects a reflection characteristic measured in an input port of the antenna tuner 230, only a preset limited number of tune codes may be selected. In contrast, since the second reflection coefficient reflects an actual reflection characteristic generated in an output port of the antenna tuner 230 or an input port of the antenna, more tune codes may be used in response to various frequency bands and changes in an external environment.

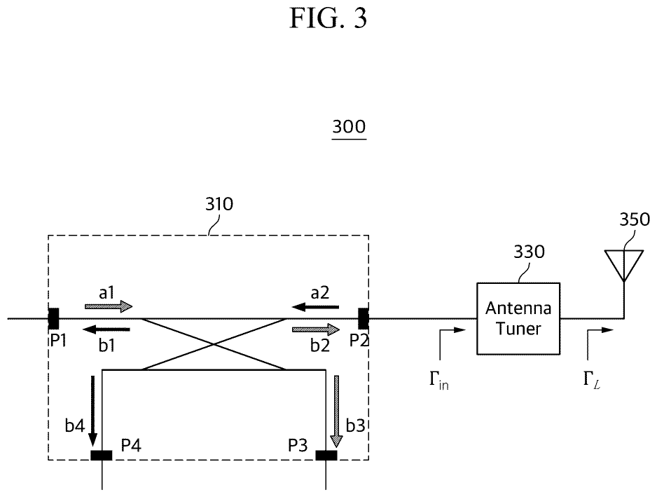

FIG. 3 is a diagram for illustrating a communication device 300 according to one or more example embodiments of the disclosure.

Referring to FIG. 3, the communication device 300 may include a coupler 310, an antenna tuner 330, and an antenna 350. In one or more example embodiments, the communication device 300 may further include a processor and memory. In one or more example embodiments, the communication device 300 of FIG. 3 may be an example of the communication devices 100 and 200 of FIGS. 1 and 2.

The coupler 310 may include an input port P1 and an output port P2. The input port P1 of the coupler 310 may be connected to an output port of a transmitter, and the output port P2 of the coupler 310 may be connected to an input port of the antenna tuner 330. For example, the output port P2 of the coupler 310 may be connected to the antenna 350 through the antenna tuner 330. In one or more example embodiments, the coupler 310 may include a first feedback port P3 and a second feedback port P4. In one or more example embodiments, the first feedback port P3 and the second feedback port P4 of the coupler 310 may be connected to a feedback circuit. In one or more example embodiments, the first feedback port P3 and the second feedback port P4 of the coupler 310 may be connected to the processor.

For example, at least a portion of a transmission signal provided from the transmitter may be transmitted to the input port P1 of the coupler 310 as a first forward signal a1. At least a portion of the first forward signal a1 may be transmitted to the first feedback port P3 of the coupler 310 as a feedback forward signal b3. At least a portion of the first forward signal a1 may be transmitted to the output port P2 of the coupler 310 as a second forward signal b2. For example, at least a portion of a reverse signal reflected from the antenna 350 may be transmitted to the output port P2 of the coupler 310 as a first reverse signal a2. At least a portion of the first reverse signal a2 may be transmitted to the second feedback port P4 of the coupler 310 as a feedback reverse signal b4. At least a portion of the first reverse signal a2 may be transmitted to the input port P1 of the coupler 310 as a second reverse signal b1.

In one or more example embodiments, the coupler 310 may capture the feedback forward signal b3 of the forward signal and the feedback reverse signal b4 of the reverse signal. In an example case in which a forward coupling direction is set, the coupler 310 may capture the feedback forward signal b3 from the first forward signal a1. In an example case in which a reverse coupling direction is set, the coupler 310 may capture the feedback reverse signal b4 from the first reverse signal a2. In one or more example embodiments, the coupler 310 may provide information about the feedback forward signal b3 and the feedback reverse signal b4 to the processor. In one or more example embodiments, the coupler 310 may provide the information about the feedback forward signal b3 and the feedback reverse signal b4 to the processor through the feedback circuit.

The processor may identify a ratio of the feedback reverse signal b3 and the feedback forward signal b4 (for example, b4/b3) as a first reflection coefficient Γᵢₙ of the antenna tuner 330. Here, the ratio may be a magnitude (or amplitude) ratio of signals. The first reflection coefficient Γᵢₙ may be an input reflection coefficient of the antenna tuner 330.

The processor may identify a second reflection coefficient of the antenna 350 based on the first reflection coefficient Γᵢₙ and an S-parameter set corresponding to a tune code. A second reflection coefficient Γ_{L} may be a load reflection coefficient of the antenna 350. For example, the processor may calculate a value of the second reflection coefficient Γ_{L} based on parameter values included in the S-parameter set corresponding to the tune code and the first reflection coefficient Γᵢₙ. Here, the tune code may be a tune code currently set for the antenna tuner 330. In one or more example embodiments, the processor may identify the S-parameter set corresponding to the tune code based on a lookup table. For example, the lookup table may include a plurality of tune codes and a plurality of S-parameter sets mapped to each other. For example, a first tune code among the plurality of tune codes may be associated with (or mapped to) a first S-parameter set among the plurality of S-parameter sets, and a second tune code among the plurality of tune codes may be associated with (or mapped to) a second S-parameter set among the plurality of S-parameter sets. The lookup table may be stored in the processor or a memory in advance. The processor may identify the S-parameter set corresponding to the currently set tune code in the lookup table. The S-parameter set may indicate reflection and transmission characteristics of a signal. For example, the S-parameter set may include an input reflection parameter, a reverse transmission parameter, a forward transmission parameter, and an output reflection parameter. For example, the forward transmission parameter (S21) for the coupler 310 may indicate a signal transmission ratio (for example, b2/a1) from the input port P1 to the output port P2, and the reverse transmission parameter (S12) for the coupler 310 may indicate a signal transmission ratio (for example, b1/a2) from the output port P2 to the input port P1. The input reflection parameter (S11) for the coupler 310 may indicate a ratio (for example, b1/a1) of a signal reflected from the input port P1 to a signal inputted to the input port P1, and the output reflection parameter (S22) for the coupler 310 may indicate a ratio (for example, b2/a2) of a signal reflected from the output port P2 to a signal inputted to the output port P2. However, the disclosure is not limited to thereto, and as such, the S-parameter may include other information.

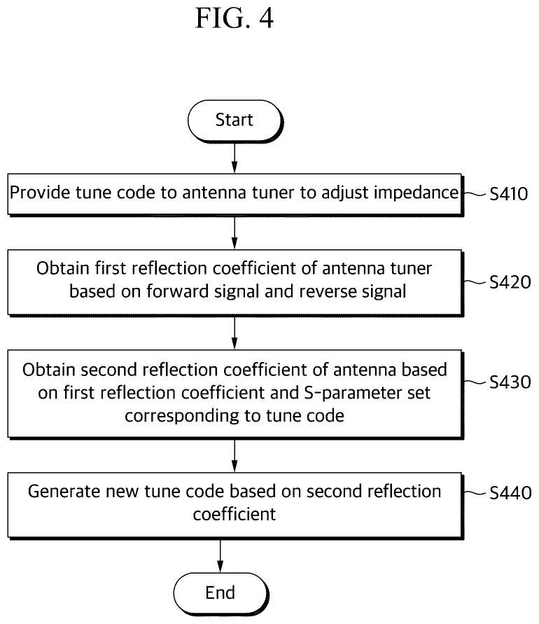

FIG. 4 is a flowchart illustrating an operating method of a device for controlling impedance of an antenna tuner according to one or more example embodiments of the disclosure. In an example embodiment, the method of FIG. 4 may be performed by the processor 210 of FIG. 2. Hereinafter, it is assumed that the processor 210 of FIG. 2 controls the antenna tuner 330 of FIG. 3, but the disclosure is not limited thereto. As illustrated in FIG. 4, the operating method of a communication device may include a plurality of operations S410 to S440.

In operation S410, the method may include providing a tune code to the antenna tuner 330 to adjust impedance. For example, the processor 210 may provide the tune code to the antenna tuner 330 to adjust impedance. In one or more example embodiments, the provided tune code may be a tune code different from a bypass tune code for adjusting the impedance of the antenna tuner 330 to a reference impedance. In one or more example embodiments, after the tune code is provided, the tune code may be preserved (or maintained) until a new tune code is provided.

In operation S420, the method may include providing obtaining a first reflection coefficient Γᵢₙ of the antenna tuner 330 based on a forward signal and a reverse signal. For example, the processor 210 may obtain the first reflection coefficient Γᵢₙ of the antenna tuner 330 based on the forward signal and the reverse signal. The forward signal may be a signal transmitted to the antenna 350 through the antenna tuner 330. The reverse signal may be a signal received through the antenna tuner 330 as at least a portion of the forward signal is reflected. The first reflection coefficient Γᵢₙ may be an input reflection coefficient as seen from an input port of the antenna tuner 330.

In operation S430, the method may include providing obtaining a second reflection coefficient Γ_{L} of the antenna 350 based on the first reflection coefficient Tin and parameter information corresponding to the tune code. For example, the processor 210 may obtain the second reflection coefficient Γ_{L} of the antenna 350 based on the first reflection coefficient Γᵢₙ and an S-parameter set corresponding to the tune code. The S-parameter set corresponding to the tune code may be an S-parameter set corresponding to a currently set tune code. The second reflection coefficient Γ_{L} may be a reflection coefficient as seen from an input port of the antenna 350 or an output port of the antenna tuner 330.

In operation S440, the method may include generating a new tune code based on the second reflection coefficient Γ_{L}. For example, the processor 210 may generate the new tune code based on the second reflection coefficient Γ_{L}.

In one or more example embodiments, the operating method of the communication device may further include, in an example case in which a frequency band of a signal transmitted through the antenna 350 is changed, generating an initial tune code corresponding to the changed frequency band. For example, based on a change in the frequency band of the signal transmitted through the antenna 350, the initial tune code corresponding to the changed frequency band may be generated. In one or more example embodiments, the operating method of the communication device may further include, until the new tune code is generated in operation S440, preserving (or maintaining) the tune code provided to the antenna tuner 330.

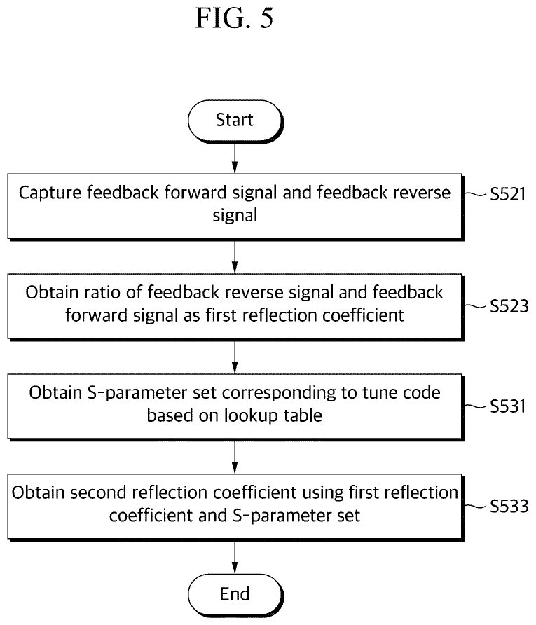

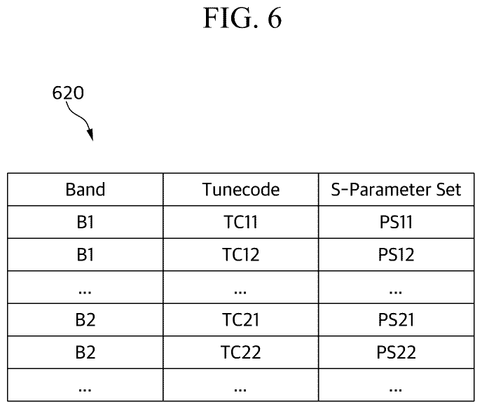

FIG. 5 is a flowchart illustrating a method of obtaining a reflection coefficient according to one or more example embodiments of the disclosure. FIG. 6 is a diagram for illustrating a lookup table 620 according to one or more example embodiments of the disclosure. In an example embodiment, the method of FIG. 5 may be performed by the processor 210 of FIG. 2. Hereinafter, it is assumed that the processor 210 of FIG. 2 controls the antenna tuner 330 of FIG. 3, but the disclosure is not limited thereto. As illustrated in FIG. 5, the method may include a plurality of operations S521, S523, S531, and S533. In one or more example embodiments, operation S521 and operation S523 of FIG. 5 may be included in operation S420 of FIG. 4, and operation S531 and operation S533 of FIG. 5 may be included in operation S430 of FIG. 4.

Referring to FIGS. 4 to 6, in operation S521, the method may include obtaining the feedback forward signal b3 and the feedback reverse signal b4. For example, the feedback forward signal b3 of a forward signal and the feedback reverse signal b4 of a reverse signal may be captured. For example, the coupler 310 may include the first feedback port P3 and the second feedback port P4 that monitor the forward signal inputted from a transmitter and the reverse signal reflected from the antenna 350 in real time. For example, the coupler 310 may capture a portion of the forward signal as the feedback forward signal b3 through the first feedback port P3 and may capture a portion of the reverse signal as the feedback reverse signal b4 through the second feedback port P4.

In operation S523, the method may include obtaining a ratio of the feedback reverse signal b4 and the feedback forward signal b3 as the first reflection coefficient Tin. For example, the processor 210 may obtain a result value calculated using the following Equation 1 as the first reflection coefficient Γᵢₙ.

$${Γ}_{i n} = \frac{b 4}{b 3} \qquad [ Equation 1 ]$$

For example, the first reflection coefficient Γᵢₙ may be defined as a value obtained by dividing a magnitude of the feedback reverse signal b4 by a magnitude of the feedback forward signal b3 according to Equation 1.

In operation S531, the method may include obtaining an S-parameter set corresponding to a tune code based on the lookup table 620. For example, operation S531 may be performed by the processor 210. For example, the processor 210 may obtain the S-parameter set corresponding to the tune code based on the lookup table 620. The lookup table 620 may include a frequency band, a tune code, and an S-parameter set that are mapped to each other. For example, first and second tune codes TC11 and TC12 and first and second S-parameter sets PS11 and PS12 may be mapped to a first frequency band B1. For example, third and fourth tune codes TC21 and TC22 and third and fourth S-parameter sets PS21 and PS22 may be mapped to a second frequency band B2. The processor 210 may obtain an S-parameter set corresponding to a currently set tune code in the lookup table 620.

In operation S533, the method may include obtaining the second reflection coefficient Γ_{L} using the first reflection coefficient Γᵢₙ and the obtained S-parameter set. For example, the processor 210 may obtain a result value calculated using Equation 2 as the second reflection coefficient Γ_{L}.

$${Γ}_{L} = \frac{{Γ}_{i n} - {S}_{11}}{{Γ}_{i n} {S}_{22} - ( {S}_{11} {S}_{22} - {S}_{12} {S}_{21} )} \qquad [ Equation 2 ]$$

Here, the second reflection coefficient Γ_{L} of the first antenna 215-2 may be defined by a relationship between the first reflection coefficient Γᵢₙ, a forward transmission parameter S21, a reverse transmission parameter S12, an input reflection parameter S11, and an output reflection parameter S22 included in the S-parameter set according to Equation 2. Equation 2 is merely an example embodiment, and the second reflection coefficient Γ_{L} may be calculated in another manner.

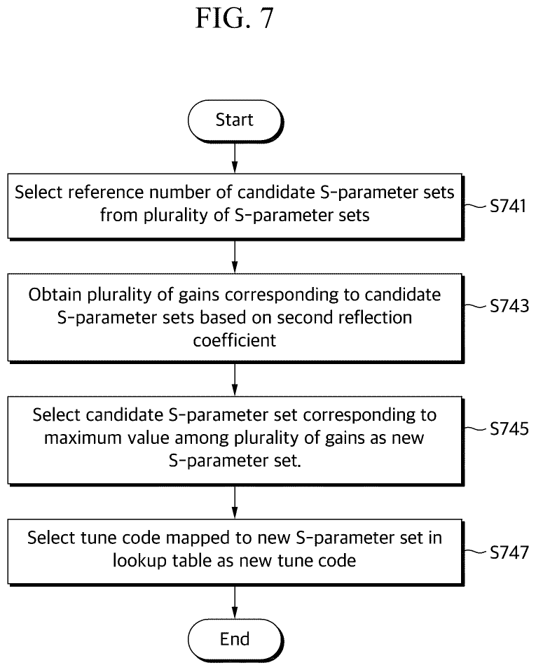

FIG. 7 is a flowchart illustrating a method of selecting a new tune code according to one or more example embodiments of the disclosure. In an example embodiment, the method of FIG. 7 may be performed by the processor 210 of FIG. 2, but the disclosure is not limited thereto. Hereinafter, it is assumed that the processor 210 of FIG. 2 controls the antenna tuner 330 of FIG. 3. As illustrated in FIG. 7, the method may include a plurality of operations S741, S743, S745, and S747. In an example embodiment, the plurality of operations S741, S743, S745, and S747 of FIG. 7 may be included in operation S440 of FIG. 4.

Referring to FIGS. 4 to 7, in one or more example embodiments, operation S440 of FIG. 4 of setting the new tune code may include an operation of selecting a new S-parameter set based on a gain of the antenna tuner 330, and operations S741, S743, and S745 of FIG. 7 may be included in the operation of selecting the new S-parameter set based on the gain of the antenna tuner 330. For example, the processor 210 may select the new S-parameter set based on the gain of the antenna tuner 330. The gain may indicate a transmission efficiency of an output signal compared to an input signal. In one or more example embodiments, the gain may be calculated using the second reflection coefficient Γ_{L} and at least one of values included in an S-parameter set. For example, the processor 210 may select the new S-parameter set so that the gain is a maximum value.

In operation S741, the method may include selecting a reference number of candidate S-parameter sets from a plurality of S-parameter sets. For example, the processor 210 may select the reference number of S-parameter sets from the plurality of S-parameter sets included in a lookup table and determine the selected S-parameter sets as the candidate S-parameter sets. For example, the processor 210 may randomly select the reference number of S-parameter sets from the plurality of S-parameter sets. However, the disclosure is not limited thereto, and as such, according to an amendment, the processor 210 may select the reference number of S-parameter sets from the plurality of S-parameter sets based on a criterion. In other words, the candidate S-parameter set may refer to an S-parameter set selected from the plurality of S-parameter sets. In one or more example embodiments, the reference number may be preset as one of various values such as 10, 50, and 100. According to the disclosure, since a gain is calculated using not all but some S-parameter sets by selecting candidate S-parameter sets, operation efficiency may be increased and a delay caused by operation may be minimized. In one or more example embodiments, operation S741 may be omitted.

In operation S743, the method may include obtaining a plurality of gains each corresponding to the candidate S-parameter sets among the plurality of S-parameter sets based on the second reflection coefficient Γ_{L}. For example, the processor 210 may repeatedly calculate a gain corresponding to one S-parameter set, among the candidate S-parameter sets, using the second reflection coefficient Γ_{L} and the one S-parameter set. The candidate S-parameter set may include a forward transmission parameter (for example, S₂₁) indicating a ratio of a forward signal transmitted from an input port to an output port and an output reflection parameter (for example, S₂₂) indicating a ratio of a reverse signal reflected from the output port. For example, the processor 210 may calculate a gain using the following Equation 3.

$${G}_{t} = \frac{{\vert {S}_{21} \vert}^{2} ( 1 - {\vert {Γ}_{L} \vert}^{2} )}{{\vert 1 - {S}_{22} {Γ}_{L} \vert}^{2}} \qquad [ Equation 3 ]$$

Here, a gain Gt may be defined by a relationship between the second reflection coefficient ΓL, a forward transmission parameter S21, and an output reflection parameter S22 included in a candidate S-parameter set according to Equation 3. In one or more example embodiments, the gain Gt may have a greater value as a value of the forward transmission parameter S21 increases. Equation 3 is merely an example embodiment, and the gain Gt may be calculated in another manner.

In operation S745, the method may include selecting a candidate S-parameter set corresponding to a maximum value among the plurality of gains as a new S-parameter set. For example, the processor 210 may select a candidate S-parameter set providing a gain of the maximum value among gains calculated for each candidate S-parameter set as the new S-parameter set.

In operation S747, the method may include selecting a tune code mapped to the new S-parameter set as a new tune code. For example, the processor 210 may generate the new tune code from a tune code corresponding to the candidate S-parameter set providing the gain of the maximum value, with reference to a lookup table in which a plurality of tune codes and S-parameter sets are mapped to each other, and provide the new tune code.

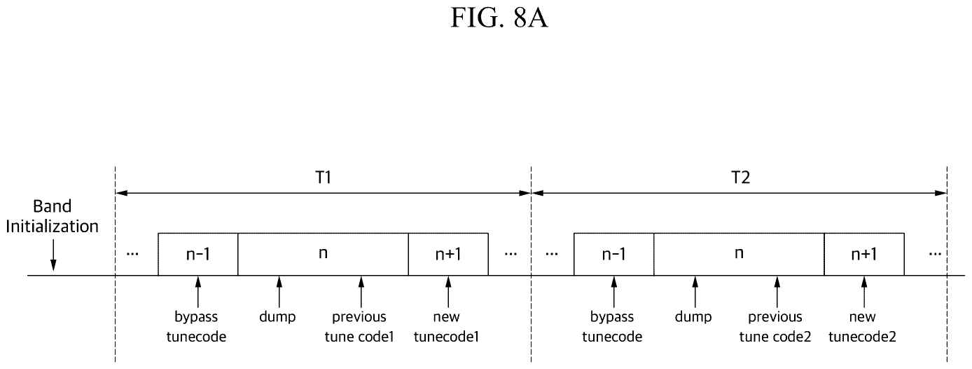

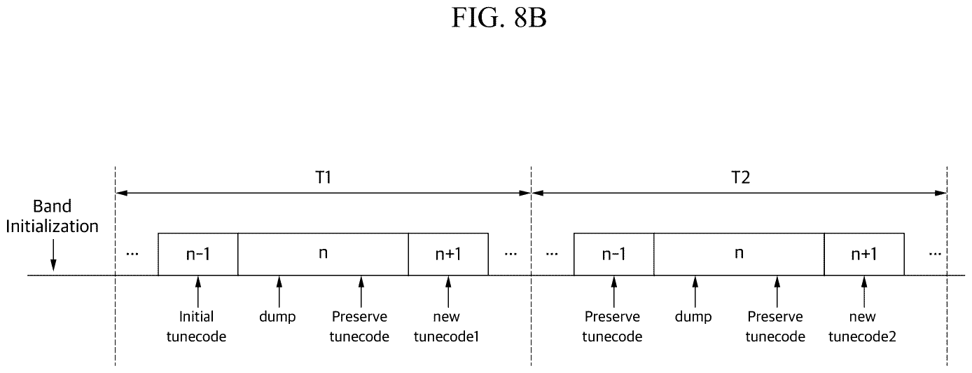

FIGS. 8A and 8B are diagrams for illustrating example embodiments of generating a new tune code. The example embodiment of FIG. 8A (hereinafter referred to as a first example) and the example embodiment of FIG. 8B (hereinafter referred to as a second example) may be performed by the communication device 200 of FIG. 2 or the communication device 300 of FIG. 3. Hereinafter, it is assumed that the processor 210 of FIG. 2 controls the antenna tuner 330 of FIG. 3.

In FIGS. 8A and 8B, a frequency band of a signal transmitted through the antenna 350 may be changed previous to a first time period T1, and the first time period T1 may represent a time period immediately subsequent to a change in the frequency band of the signal transmitted through the antenna 350. A second time period T2 may represent a time period immediately subsequent to the first time period T1. Each of the first time period T1 and the second time period T2 may include a plurality of transmission time intervals (TTIs). Each TTI may be represented as sequential numbers such as n−1, n, and n+1. Here, n is an integer greater than 1. For example, each of the first time period T1 and the second time period T2 may have a time length of 1 second. However, this is merely an example embodiment, and the time length may be modified and implemented in various manners.

Referring to FIG. 8A, in the first example, during the (n−1)th TTI of the first time period T1, the processor 210 may generate a bypass tune code. The bypass tune code may be a tune code for adjusting impedance of the antenna tuner 330 to a reference impedance (for example, 50Ω). The processor 210 may provide the bypass tune code to the antenna tuner 330. The antenna tuner 330 may adjust the impedance to the reference impedance corresponding to the bypass tune code.

Subsequently, during the (n)th TTI of the first time period T1, the processor 210 may perform a dump operation of setting (or converting) a coupling direction of the coupler 310. The dump operation may include a first sub-dump operation of setting a forward coupling direction and a second sub-dump operation of setting a reverse coupling direction. Meanwhile, an order of the coupling direction may be modified and implemented opposite thereto. For example, the sequence of setting the coupling direction for signal sampling may be flexibly adjusted according to system requirements, such that the sampling may be performed in the sequence of forward to reverse, or in the sequence of reverse to forward. The coupler 310 may capture the feedback forward signal b3 from a forward signal while the forward coupling direction is set and capture the feedback reverse signal b4 from a reverse signal while the reverse coupling direction is set. The processor 210 may obtain information about the feedback forward signal b3 and the feedback reverse signal b4. Meanwhile, the processor 210 may provide a tune code (hereinafter referred to as a first previous tune code) provided previous to the bypass tune code to the antenna tuner 330 again. The antenna tuner 330 may adjust the impedance to an impedance corresponding to the first previous tune code.

Subsequently, during the (n+1)th TTI of the first time period T1, the processor 210 may determine a reflection coefficient based on the feedback forward signal b3 and the feedback reverse signal b4 and generate a new tune code (hereinafter referred to as a first new tune code) based on the reflection coefficient. The processor 210 may provide the first new tune code to the antenna tuner 330. The antenna tuner 330 may adjust the impedance to an impedance corresponding to the first new tune code.

Subsequently, during the (n−1)th TTI of the second time period T2, the processor 210 may provide the bypass tune code to the antenna tuner 330 again. The antenna tuner 330 may adjust the impedance to the reference impedance again according to the bypass tune code.

Subsequently, during the (n)th TTI of the second time period T2, the processor 210 may perform the dump operation of setting (or converting) the coupling direction of the coupler 310 and obtain information about the feedback forward signal b3 and the feedback reverse signal b4. Meanwhile, the processor 210 may provide a tune code (hereinafter referred to as a second previous tune code) set immediately previous to the bypass tune code to the antenna tuner 330 again. The second previous tune code may be the first new tune code generated previously.

During the (n+1)th TTI of the second time period T2, the processor 210 may determine a reflection coefficient based on the feedback forward signal b3 and the feedback reverse signal b4 and generate a second new tune code based on the reflection coefficient. The processor 210 may provide the second new tune code to the antenna tuner 330.

Referring to FIG. 8B, in the second example, during the (n−1)th TTI of the first time period T1, the processor 210 may generate an initial tune code corresponding to a frequency band. The initial tune code corresponding to the frequency band may be a preset tune code. The initial tune code may be set differently for each frequency band. In an example embodiment, the initial tune code may be a tune code different from a bypass tune code. The processor 210 may provide the initial tune code to the antenna tuner 330. The antenna tuner 330 may adjust impedance to an impedance corresponding to the initial tune code.

Subsequently, during the (n)th TTI of the first time period T1, the processor 210 may perform a dump operation. The dump operation may include a first sub-dump operation of setting a forward coupling direction for the coupler 310 and a second sub-dump operation of setting a reverse coupling direction. The coupler 310 may capture the feedback forward signal b3 from a forward signal while the forward coupling direction is set and capture the feedback reverse signal b4 from a reverse signal while the reverse coupling direction is set. The processor 210 may obtain information about the feedback forward signal b3 and the feedback reverse signal b4 that are captured through the dump operation.

In one or more example embodiments, the processor 210 may preserve (or maintain) a tune code provided to the antenna tuner 330 until a new tune code is generated. In one or more example embodiments, the preserved tune code may be a tune code different from the bypass tune code. In other words, unlike the first example of providing the first previous tune code provided previous to the bypass tune code, the second example may preserve the initial tune code without a change to a tune code provided previous to the initial tune code.

Subsequently, during the (n+1)th TTI of the first time period T1, the processor 210 may identify the first reflection coefficient Γᵢₙ based on the feedback forward signal b3 and the feedback reverse signal b4. The processor 210 may identify the second reflection coefficient ΓL based on the first reflection coefficient Γin and an S-parameter set corresponding to the initial tune code. The processor 210 may generate a first new tune code based on the second reflection coefficient ΓL and provide the first new tune code to the antenna tuner 330.

In the second time period T2, a process similar to the first time period T1 may be repeated. During the (n−1)th TTI of the second time period T2, the processor 210 may preserve a tune code provided to the antenna tuner 330. In other words, the processor 210 may preserve the first new tune code. In this case, the impedance of the antenna tuner 330 may be preserved as an impedance corresponding to the first new tune code. Subsequently, during the (n)th TTI of the second time period T2, the processor 210 may perform the dump operation and preserve the first new tune code until a change to a second new tune code. Subsequently, during the (n+1)th TTI of T2, the processor 210 may identify the first reflection coefficient Γin based on the feedback forward signal b3 and the feedback reverse signal b4 and identify the second reflection coefficient ΓL based on the first reflection coefficient Γin and an S-parameter set corresponding to the first new tune code. The processor 210 may generate the second new tune code based on the second reflection coefficient ΓL and provide the second new tune code to the antenna tuners 230 and 330. The second example, compared to the first example, may optimize impedance matching while minimizing a change in tune codes and impedance of the antenna tuners 230 and 330. In addition, the return loss of the communication devices 200 and 300 may be dynamically minimized in an environment such as conversion to various frequency bands.

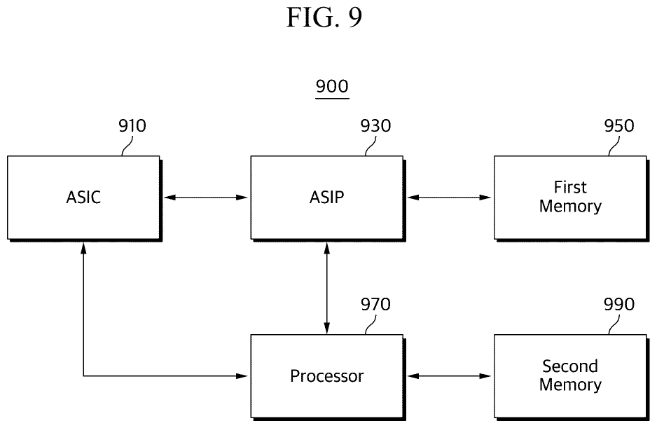

FIG. 9 is a block diagram illustrating an example of a communication device 900 according to one or more example embodiments of the disclosure. In an example embodiment, the communication device 900 may include an application specific integrated circuit (ASIC) 910, an application specific instruction set processor (ASIP) 930, a first memory 950, a processor 970, and a second memory 990. However, the disclosure is not limited thereto, and as such, according to an embodiment, in the communication device 900, one or more components may be added, omitted or combined. For example, a number and/or a type of processor may be different. Also, the number and/or a type of memory may be different. Two or more of the ASIC 910, the ASIP 930, and the processor 970 may communicate with each other. In addition, at least two or more of the ASIC 910, the ASIP 930, the first memory 950, the processor 970, and the second memory 990 may be embedded in a single chip.

The ASIP 930 may be an integrated circuit customized for a specific use and may support a dedicated instruction set for a specific application and execute instructions included in the instruction set. The first memory 950 may communicate with the ASIP 930 and may be a non-transitory storage device to store a plurality of instructions executed by the ASIP 930. For example, the first memory 950 may include any type of memory accessible by the ASIP 930. For example, the first memory 950 may include, but is not limited to, random access memory (RAM), read only memory (ROM), a tape, a magnetic disk, an optical disk, volatile memory, non-volatile memory, and a combination thereof, given as non-restrictive examples.

The processor 970 may control the communication device 900 by executing a plurality of instructions. For example, the processor 970 may be referred to as a main processor or a primary processor. For example, the processor 970 may control the ASIC 910 and the ASIP 930 and may process data received through a wireless communication network or process a user input for the communication device 900. The second memory 990 may communicate with the processor 970 and may be a non-transitory storage device to store the plurality of instructions executed by the processor 970. For example, the second memory 990 may be referred to as a main memory or a primary memory. For example, the second memory 990 may include any type of memory accessible by the processor 970, such as RAM, ROM, a tape, a magnetic disk, an optical disk, volatile memory, non-volatile memory, and a combination thereof, given as non-restrictive examples.

According to an embodiment, a method of adjusting the impedance of the antenna tuners 230 and 330 described above may be performed by at least one of the components included in the communication device 900 of FIG. 9. In some example embodiments, the operation of the processor 210 of FIG. 2 may be implemented by the plurality of instructions stored in the first memory 950, and the ASIP 930 may perform at least one operation in a method of measuring a reflection coefficient of an antenna by executing the plurality of instructions stored in the first memory 950. In some example embodiments, at least one operation in the method of adjusting the impedance of the antenna tuners 230 and 330 may be performed by a hardware block designed through logic synthesis, and the hardware block may be included in the ASIC 910. In some example embodiments, at least one operation in the method of measuring the reflection coefficient of the antenna may be implemented by the plurality of instructions stored in the second memory 990, and the processor 970 may perform at least one operation in the method of measuring the reflection coefficient of the antenna by executing the plurality of instructions stored in the second memory 990.

As above, example embodiments are disclosed in the specification and drawings. While particular terms are used to describe example embodiments herein, the terms are merely used to describe the technical idea of the disclosure and not intended to limit meanings or limit the scope of the disclosure specified in the claims. Therefore, a person of ordinary skill in the art may understand that various modifications and other equivalent example embodiments may be made therefrom.

What is claimed is:

1. A communication device comprising:
an antenna tuner configured to adjust impedance based on a first tune code; and
a processor configured to:
obtain a first reflection coefficient of the antenna tuner based on a forward signal transmitted to an antenna through the antenna tuner and a reverse signal received through the antenna tuner, the reverse signal comprising at least a portion of a reflected signal of the forward signal;
obtain a second reflection coefficient of the antenna based on the first reflection coefficient and a first scattering parameter (S-parameter) set corresponding to the first tune code; and
generate a second tune code based on the second reflection coefficient.

2. The communication device of claim 1, wherein the processor is further configured to:
select a second S-parameter set based on a gain of the antenna tuner; and
select the second tune code based on the second S-parameter set.

3. The communication device of claim 2, wherein the processor is further configured to:
determine a plurality of gains corresponding to a plurality of candidate S-parameter sets among a plurality of S-parameter sets based on the second reflection coefficient; and
select a candidate S-parameter set, among the plurality of candidate S-parameter sets, corresponding to a maximum value among the plurality of gains as the second S-parameter set.

4. The communication device of claim 3, further comprising:
a coupler comprising an input port and an output port connected to the antenna,
wherein each of the plurality of candidate S-parameter sets comprises:
a forward transmission parameter indicating a ratio of the forward signal transmitted from the input port to the output port; and
an output reflection parameter indicating a ratio of the reverse signal reflected from the output port.

5. The communication device of claim 4, wherein the gain of the antenna tuner has a greater value as a value of the forward transmission parameter increases.

6. The communication device of claim 3, wherein the processor is further configured to select a reference number of the plurality of candidate S-parameter sets from the plurality of S-parameter sets.

7. The communication device of claim 2, wherein the processor is further configured to obtain the first S-parameter set corresponding to the first tune code based on a lookup table in which a plurality of tune codes and a plurality of S-parameter sets mapped with each other.

8. The communication device of claim 1, further comprising a coupler configured to capture a feedback forward signal of the forward signal and a feedback reverse signal of the reverse signal,
wherein the processor is further configured to obtain a ratio of the feedback reverse signal and the feedback forward signal as the first reflection coefficient.

9. The communication device of claim 1, wherein the processor is further configured to, based on a change in a frequency band of a signal transmitted through the antenna, generate an initial tune code corresponding to the changed frequency band.

10. The communication device of claim 1, wherein the processor is further configured to maintain the first tune code provided to the antenna tuner until the second tune code is generated.

11. The communication device of claim 1, wherein the first tune code is different from a bypass tune code configured to adjust the impedance to a reference impedance.

12. An operating method of a device for controlling impedance of an antenna tuner, the operating method comprising:
providing a first tune code to the antenna tuner to adjust impedance;
obtaining a first reflection coefficient of the antenna tuner based on a forward signal transmitted to an antenna through the antenna tuner and a reverse signal received through the antenna tuner, the reverse signal comprising at least a portion of a reflected signal of the forward signal;
obtaining a second reflection coefficient of the antenna based on the first reflection coefficient and first scattering parameter (S-parameter) set corresponding to the first tune code; and
generating a second tune code based on the second reflection coefficient.

13. The operating method of claim 12, wherein the generating the second tune code comprises:
selecting a second S-parameter set based on a gain of the antenna tuner; and
selecting the second tune code based on the second S-parameter set.

14. The operating method of claim 13, wherein the selecting the second S-parameter set comprises:
determining a plurality of gains corresponding to a plurality of candidate S-parameter sets among a plurality of S-parameter sets based on the second reflection coefficient; and
selecting a candidate S-parameter set, among the plurality of candidate S-parameter sets, corresponding to a maximum value among the plurality of gains as the second S-parameter set.

15. The operating method of claim 14, wherein the selecting the second S-parameter set further comprises selecting a reference number of the plurality of candidate S-parameter sets from the plurality of S-parameter sets.

16. The operating method of claim 13, further comprising obtaining the first S-parameter set corresponding to the first tune code based on a lookup table in which a plurality of tune codes and a plurality of S-parameter sets mapped with each other.

17. The operating method of claim 12, wherein the obtaining the first reflection coefficient of the antenna tuner comprises:
capturing a feedback forward signal of the forward signal and a feedback reverse signal of the reverse signal; and
obtaining a ratio of the feedback reverse signal and the feedback forward signal as the first reflection coefficient.

18. The operating method of claim 12, further comprising, based on a change in a frequency band of a signal transmitted through the antenna, generating an initial tune code corresponding to the changed frequency band.

19. The operating method of claim 12, further comprising maintaining the first tune code provided to the antenna tuner until the second tune code is generated.

20. A device configured to control impedance of an antenna tuner, the device comprising:
a buffer configured to store a lookup table comprising a plurality of tune codes; and
an antenna controller configured to provide a first tune code to the antenna tuner,
wherein the antenna controller is configured to:
receive a first signal corresponding to a forward signal transmitted to an antenna through the antenna tuner;
receive a second signal corresponding to a reverse signal received through the antenna tuner, the reverse signal comprising at least a portion of a reflected signal of the forward signal;
obtain a first reflection coefficient of the antenna tuner based on the first signal and the second signal;
obtain a second reflection coefficient of the antenna based on the first reflection coefficient and the first tune code; and
generate a second tune code based on the second reflection coefficient and the lookup table.
